(19) United States
(12) Patent Application Publication
(10) Pub. No.: US 2026/0169856 A1
(43) Pub. Date: Jun. 18, 2026

(54) MANAGING PARITY DATA IN A MEMORY SYSTEM

(71) Applicant: Yangtze Memory Technologies Co., Ltd., Wuhan (CN)

(72) Inventor: Xianwu LUO, Wuhan (CN)

(21) Appl. No.: 19/023,918

(22) Filed: Jan. 16, 2025

(30) Foreign Application Priority Data
Dec. 18, 2024 (CN) 202411876431.4

(51) Int. Cl. G06F 11/10; G06F 13/16

(52) U.S. Cl. CPC G06F 11/108; G06F 11/1016; G06F 13/1668

(57) ABSTRACT

Methods, apparatus, and systems for managing parity data generation are provided. In one aspect, a memory system includes a memory device and a memory controller coupled to the memory device. The memory device includes memory blocks programmable in a first storage mode or a second storage mode, where the first storage mode has a lower storage density than the second storage mode. The memory controller is configured to perform operations including generating, based on the second storage mode, parity data corresponding to user data; writing, in the first storage mode, the user data and the parity data to a first set of memory blocks; and writing, in the second storage mode, the user data and the parity data that are read from the first set of memory blocks to a second set of memory blocks.

### CROSS-REFERENCE TO RELATED APPLICATIONS

This application claims priority to Chinese Patent Application No. 202411876431.4, filed on Dec. 18, 2024, which is hereby incorporated by reference in its entirety.

### TECHNICAL FIELD

The present disclosure generally relates to memory devices and memory systems, and in particular, to managing parity data in memory systems.

### BACKGROUND

Flash memory is a low-cost, high-density, nonvolatile solid-state storage medium that can be electrically erased and reprogrammed. Flash memory includes NOR flash memory and NAND flash memory. Various operations can be performed by flash memory, for example, program (write) and erase operations, to change the threshold voltage of each memory cell to a respective level. For NAND flash memory, an erase operation can be performed at the memory block level, a program operation can be performed at the page level, and a read operation can be performed at the page level.

### SUMMARY

The present disclosure involves methods, apparatuses, and systems for managing parity data in memory systems. One aspect of the present disclosure features a memory system including a memory device and a memory controller coupled to the memory device. The memory device includes memory blocks programmable in a first storage mode or a second storage mode, where the first storage mode has a lower storage density than the second storage mode. The memory controller is configured to perform operations including generating, based on the second storage mode, parity data corresponding to user data; writing, in the first storage mode, the user data and the parity data to a first set of memory blocks; and writing, in the second storage mode, the user data and the parity data that are read from the first set of memory blocks to a second set of memory blocks.

In some implementations, the first storage mode is a single-level cell (SLC) mode. A memory cell in the first set of memory blocks stores one bit of data. The second storage mode is a multi-level cell (MLC) mode, a memory cell in the second set of memory blocks stores two or more bits of data. The parity data includes redundant array of independent disks (RAID) parity data.

In some implementations, the second storage mode is a QLC mode. The parity data includes N parity data portions. Each parity data portion is generated by performing exclusive OR (XOR) operations on M user data portions in the first set of memory blocks. Each of the M user data portions corresponds to one of M word lines, and N and M are positive integers. The M word lines are separated from each other by three word lines.

In some implementations, the second storage mode is a penta-level cell (PLC) mode. The parity data includes N parity data portions. Each parity data portion is generated by performing XOR operations on M user data portions in the first set of memory blocks. Each of the M user data portions corresponds to one of M word lines, and N and M are positive integers. The M word lines are separated from each other by four word lines.

In some implementations, a Redundant Array of Independent Disks (RAID) encoder of the memory controller is disabled when writing the user data and the parity data to the second set of memory blocks.

In some implementations, data in the first set of memory blocks is associated with a first set of pages numbered in sequence, and data in the second set of memory blocks is associated with a second set of pages numbered in sequence. Writing the user data and the parity data that are read from the first set of memory blocks to the second set of memory blocks includes reading data associated with one or more first pages of the first set of pages; and writing the data to one or more second pages of the second set of pages. Page numbers of the one or more first pages and page numbers of the one or more second pages are identical.

In some implementations, a first position of the parity data relative to the user data in the first set of memory blocks is identical to a second position of the parity data relative to the user data in the second set of memory blocks.

In some implementations, the memory controller is configured to perform the operations in response to receiving, from a host, a write command to write the user data.

In some implementations, the operations include, in response to detecting a write failure when writing the user data and the parity data to the second set of memory blocks, reading the user data and the parity data from the first set of memory blocks again.

In some implementations, the operations include, in response to detecting a read failure when reading the user data from the second set of memory blocks, recovering the user data using the parity data from the second set of memory blocks.

Another aspect of the present disclosure features a memory controller. The memory controller includes a processor and an interface. The processor is configured to perform operations including generating parity data corresponding to user data based on a second storage mode that has a higher storage density than a first storage mode; sending, through the interface, one or more first write commands to write the user data and the parity data to a first set of memory blocks in the first storage mode; sending, through the interface, one or more read commands to read the user data and the parity data from the first set of memory blocks; and sending, through the interface, one or more second write commands to write the user data and the parity data to a second set of memory blocks in the second storage mode.

In some implementations, a Redundant Array of Independent Disks (RAID) encoder of the memory controller is disabled when writing the user data and the parity data to the second set of memory blocks.

In some implementations, the first storage mode is a single-level cell (SLC) mode. A memory cell in the first set of memory blocks stores one bit of data. The second storage mode is a multi-level cell (MLC) mode, a memory cell in the second set of memory blocks stores two or more bits of data. The parity data includes redundant array of independent disks (RAID) parity data.

In some implementations, the second storage mode is a QLC mode. The parity data includes N parity data portions. Each parity data portion is generated by performing exclusive OR (XOR) operations on M user data portions in the first set of memory blocks. Each of the M user data portions corresponds to one of M word lines, and N and M are positive integers. The M word lines are separated from each other by three word lines.

In some implementations, the second storage mode is a penta-level cell (PLC) mode. The parity data includes N parity data portions. Each parity data portion is generated by performing XOR operations on M user data portions in the first set of memory blocks. Each of the M user data portions corresponds to one of M word lines, and N and M are positive integers. The M word lines are separated from each other by four word lines.

In some implementations, the operations include, in response to detecting a write failure when writing the user data and the parity data to the second set of memory blocks, reading the user data and the parity data from the first set of memory blocks again.

In some implementations, the operations include, in response to detecting a read failure when reading the user data from the second set of memory blocks, recovering the user data using the parity data from the second set of memory blocks.

Another aspect of the present disclosure features a method of operating a memory system. The method includes generating parity data corresponding to user data based on a second storage mode that has a higher storage density than a first storage mode; writing the user data and the parity data to a first set of memory blocks in the first storage mode; and writing the user data and the parity data that are read from the first set of memory blocks to a second set of memory blocks in the second storage mode.

In some implementations, the method further includes, in response to detecting a write failure when writing the user data and the parity data to the second set of memory blocks, reading the user data and the parity data from the first set of memory blocks again.

In some implementations, the method further includes, in response to detecting a read failure when reading the user data from the second set of memory blocks, recovering the user data using the parity data from the second set of memory blocks.

Another aspect of the present disclosure features a non-transitory, computer-readable medium. The non-transitory, computer-readable medium stores one or more instructions executable by a memory system to perform operations including generating parity data corresponding to user data based on a second storage mode that has a higher storage density than a first storage mode; writing the user data and the parity data to a first set of memory blocks in the first storage mode; and writing the user data and the parity data that are read from the first set of memory blocks to a second set of memory blocks in the second storage mode.

While generally described as computer-implemented software embodied on tangible media that processes and transforms the respective data, some or all of the aspects may be computer-implemented methods or further included in respective systems or other devices for performing this described functionality. The details of these and other aspects and implementations of the present disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 illustrates a block diagram of an example system having a memory device.

FIGS. 2A-2B illustrate example storage products.

FIG. 3A illustrates an example of a schematic diagram of a memory device including peripheral circuits.

FIG. 3B illustrates an example of a schematic diagram of a memory block including strings.

FIG. 4 illustrates some example peripheral circuits.

FIG. 5 illustrates an example of a block diagram of an example memory controller interacting with a host and a memory device.

FIG. 6A illustrates an example data structure in an example memory device.

FIG. 6B illustrates an example process of writing data to the example memory device as shown in FIG. 6A.

FIG. 7A illustrates an example data structure in an example memory device.

FIG. 7B illustrates an example process of writing data to the example memory device as shown in FIG. 7A.

FIG. 7C illustrates another example process of writing data to the example memory device as shown in FIG. 7A.

FIG. 8 illustrates a flowchart of an example process of operating a memory system.

Like reference numbers and designations in the various drawings indicate like elements.

### DETAILED DESCRIPTION

This specification relates to memory controllers, memory systems, and methods for managing parity data in memory systems. Redundant-array-of-independent-disks (RAID) parity data can be used to recover data in case of read failure, for example, due to one word line failure. A memory system can generate RAID parity data by performing exclusive OR (XOR) operations on data portions across one or more word lines.

A memory device of the memory system can be configured to operate in a multi-level cell mode (MLC), for example, a quad-level cell (QLC) mode. In some cases, to increase the speed of write operations, the memory system can first perform cache writing by writing data to memory blocks configured in a single-level cell (SLC) mode, and then move the data from memory blocks in the SLC mode to memory blocks in the MLC mode, by writing the data read from the memory blocks in the SLC mode to memory blocks in the MLC mode. For example, when the MLC mode is a QLC mode, during cache writing, the memory system may generate first redundant array of independent disks (RAID) parity data by implementing a 2 WL RAID scheme, and write the first RAID parity data to the memory blocks in the SLC mode. When moving the data from memory blocks in the SLC mode to memory blocks in the QLC mode, the memory system may generate second RAID parity data by implementing a 1 WL RAID scheme, and write the second RAID parity data to the memory blocks in the QLC mode. A large buffer space in the memory controller may be required to store intermediate results for generating the first and the second RAID parity data. The required buffer space may sometimes exceed the storage capacity provided by the Random-Access Memory (RAM) of the memory controller (e.g., parity buffers), or even the storage capacity of the entire RAM. In such case, the memory controller may need to perform swap operations by sending the intermediate results to the memory device for temporary storage and retrieving them when needed, which may affect the overall efficiency of write operations.

In some cases, when moving the data from memory blocks in the SLC mode to memory blocks in the MLC mode, instead of generating the second RAID parity data, the memory controller can perform read verification on the data written to the memory blocks in the MLC mode, for example, by decoding the corresponding low-density parity check (LDPC) codes to determine whether the data can be read successfully. It may take extra time to perform the read verification, which may affect the overall performance of the memory system.

The present disclosure provides techniques to generate RAID parity data while reducing the need for buffer space. In some implementations, during cache writing, the memory system can generate RAID parity data by implementing a RAID scheme that is compatible with the MLC mode (e.g., QLC mode). For example, the memory system can implement a 4 WL RAID scheme when writing data to the memory blocks in the SLC mode, such that the generated RAID parity data can be the same as if the data were to be written to the memory blocks in the QLC mode and corresponding RAID parity data were to be generated by implementing a 1 WL RAID scheme. As such, when moving data from memory blocks in the SLC mode to memory blocks in the QLC mode, the memory system can read the data and the RAID parity data from the memory blocks in the SLC mode and write them directly to the memory blocks in the QLC mode, without needing to generate RAID parity data again.

The described techniques can achieve one or more technical effects. For example, since the memory system does not need to generate RAID parity data when moving data to memory blocks in the MLC mode (e.g., QLC mode), the need for buffer space can be reduced, and the speed of write operations can be increased. For another example, since the memory blocks in the MLC mode also include RAID parity data, the memory system does not need to perform read verification on data stored in the memory blocks in the MLC mode. Further, the described techniques can generate RAID parity data that is effective for both the memory blocks in the SLC mode and the memory blocks in the MLC mode. For example, the RAID parity data can be used to recover data in case of a program failure in the memory blocks in the SLC mode, and/or recover data in case of a read failure in the memory blocks in the MLC mode. In some implementations, additional or different technical effects can be achieved.

The techniques can be applied to various types of semiconductor devices, e.g., non-volatile memory (NVM) devices (such as NAND flash memory or NOR flash memory), volatile memory devices (such as DRAM memory devices), resistive random-access memory (RRAM), phase-change memory (PCM) such as phase-change random-access memory (PCRAM), spin-transfer torque (STT)-Magnetoresistive random-access memory (MRAM), among others. The techniques can also be applied to charge-trapping based memory devices, e.g., silicon-oxide-nitride-oxide-silicon (SONOS) memory devices, and floating-gate based memory devices. The techniques can be applied to three-dimensional (3D) memory devices. The techniques can be applied to various memory types, such as memory devices configured to operate in a single-level cell (SLC) mode that can store 1 bit per cell, or a multi-level cell (MLC) mode that can store 2 or more bits per cell. For example, a memory device configured to operate in an MLC mode can store 2 bits per cell, 3 bits per cell (also referred to as a triple-level cell (TLC) mode), 4 bits per cell (also referred to as a quad-level cell (QLC) mode), or five bits per cell (also referred to as a penta-level cell (PLC) mode). Additionally or alternatively, the techniques can be applied to various types of devices and systems, such as secure digital (SD) cards, embedded multimedia cards (eMMC), universal flash storage (UFS), or solid-state drives (SSDs), embedded systems, among others.

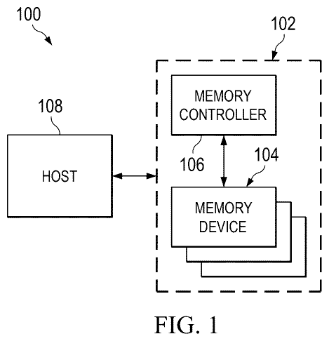

FIG. 1 illustrates a block diagram of an example system 100 having a memory device, according to some aspects of the present disclosure. The system 100 can be a mobile phone, a desktop computer, a laptop computer, a tablet, a vehicle computer, a gaming console, a printer, a positioning device, a wearable electronic device, a smart sensor, a virtual reality (VR) device, an argument reality (AR) device, or any other suitable electronic devices having storage therein. As shown in FIG. 1, the system 100 can include a host 108 and a memory system 102 having one or more memory devices 104 and a memory controller 106. The host 108 can include one or more processors of an electronic device. The processor can be a central processing unit (CPU), or a system-on-chip (SoC), such as an application processor (AP). The host 108 can be configured to send or receive data and commands to or from the memory systems 102.

The memory device 104 can be any memory device disclosed in the present disclosure, such as a NAND Flash memory device. It is noted that the NAND Flash is only one example of memory device for illustrative purposes. It can include any suitable solid-state, non-volatile memory, e.g., NOR Flash, Ferroelectric RAM (FeRAM), Phase-change memory (PCM), Magne-to-resistive random-access memory (MRAM), Spin-transfer torque magnetic random-access memory (STT-RAM), or Resistive random-access memory (RRAM), etc. In some implementations, memory device 104 includes a three-dimensional (3D) NAND Flash memory device.

The memory controller 106 can be implemented by microprocessors, microcontrollers (a.k.a. microcontroller units (MCUs)), digital signal processors (DSPs), application-specific integrated circuits (ASICs), field-programmable gate arrays (FPGAs), programmable logic devices (PLDs), state machines, gated logic, discrete hardware circuits, and other suitable hardware, firmware, and/or software configured to perform the various functions described below in detail.

The memory controller 106 is coupled to the memory device 104 and to the host 108, and is configured to control the memory device 104, according to some implementations. The memory controller 106 can manage the data stored in the memory device 104 and can communicate with the host 108. In some implementations, the memory controller 106 is designed for operating in a low duty-cycle environment, such as secure digital (SD) cards, compact Flash (CF) cards, universal serial bus (USB) Flash drives, or other media for use in electronic devices, such as personal computers, digital cameras, mobile phones, etc. In some implementations, memory controller 106 is designed for operating in a high duty-cycle environment solid state drives (SSDs) or embedded multi-media-cards (eMMCs) used as data storage for mobile devices, such as smartphones, tablets, laptop computers, etc., and enterprise storage arrays. The memory controller 106 can be configured to control operations of the memory device 104, such as read, erase, and program operations. The memory controller 106 can also be configured to manage various functions with respect to the data stored or to be stored in the memory device 104 including, but not limited to bad-block management, garbage collection, logical-to-physical address conversion, logical-to-physical mapping management, wear leveling, etc. In some implementations, the memory controller 106 is further configured to process error correction codes (ECCs) with respect to the data read from or written to the memory device 104. Any other suitable functions can be performed by the memory controller 106 as well, for example, formatting the memory device 104.

The memory controller 106 can communicate with an external device (e.g., the host 108) according to a particular communication protocol. For example, the memory controller 106 can communicate with the external device through at least one of various interface protocols, such as a USB protocol, an MMC protocol, a peripheral component interconnection (PCI) protocol, a PCI-express (PCI-E) protocol, an advanced technology attachment (ATA) protocol, a serial-ATA protocol, a parallel-ATA protocol, a small computer small interface (SCSI) protocol, an enhanced small disk interface (ESDI) protocol, an integrated drive electronics (IDE) protocol, a Firewire protocol, etc. The memory controller 106 is configured to receive and transmit a command to and from the host 108, and execute or perform multiple functions and operations provided in the present disclosure, which will be described later.

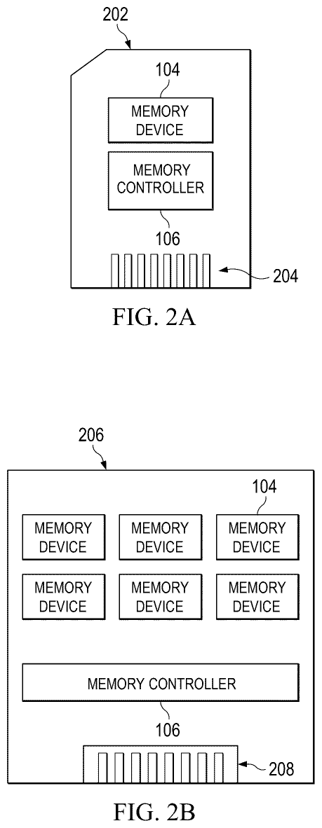

The memory controller 106 and the one or more memory devices 104 can be integrated into various types of storage devices. For example, the memory controller 106 and the one or more memory devices 104 can be packaged in a universal Flash storage (UFS) package or an eMMC package. In one example as shown in FIG. 2A, the memory controller 106 and a single memory device 104 can be integrated into a memory card 202. The memory card 202 can include a PC card (PCMCIA, personal computer memory card international association), a CF card, a smart media (SM) card, a memory stick, a multimedia card (MMC, RS-MMC, MMCmicro), an SD card (SD, miniSD, microSD, SDHC), a UFS, etc. The memory card 202 can further include a memory card connector 204 coupling the memory card 202 with a host (e.g., host 108 in FIG. 1). In another example as shown in FIG. 2B, the memory controller 106 and multiple memory devices 104 can be integrated into an SSD 206. The SSD 206 can further include an SSD connector 208 that couples the SSD 206 with a host (e.g., host 108 in FIG. 1). In some implementations, the storage capacity and/or the operation speed of the SSD 206 is greater than those of the memory card 202.

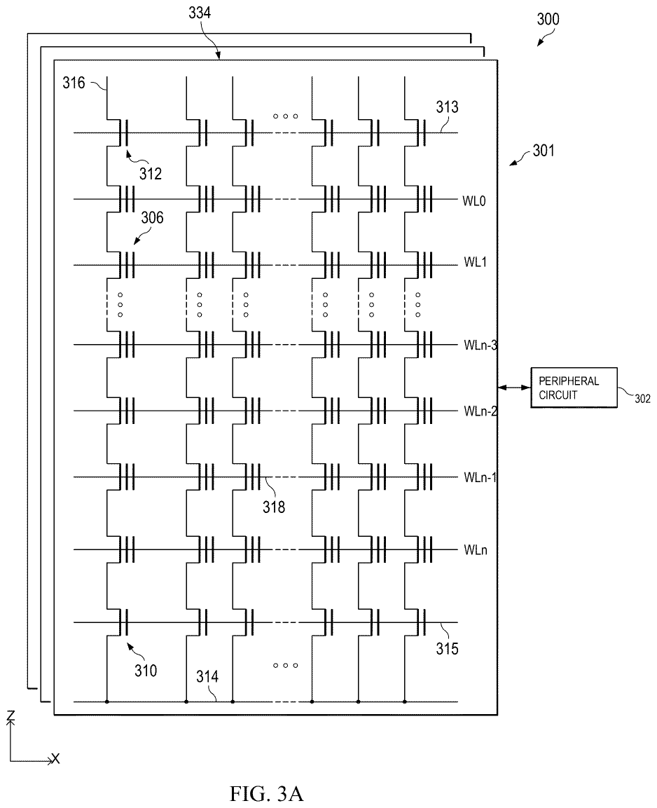

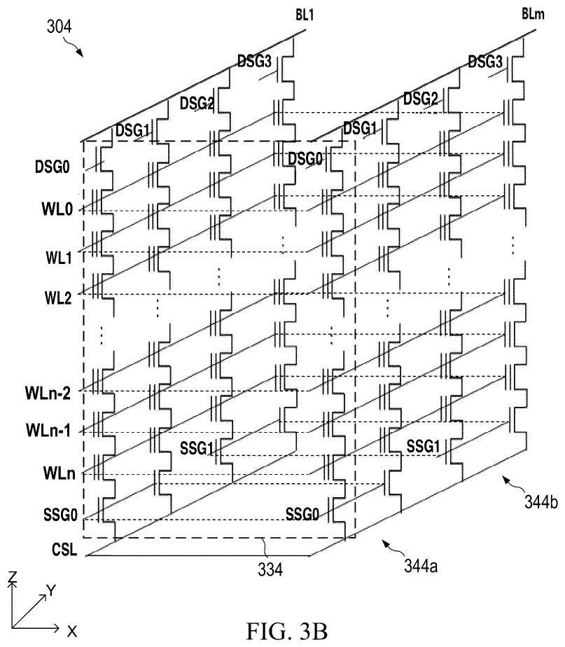

FIG. 3A illustrates an example of a schematic circuit diagram of a memory device 300, according to some aspects of the present disclosure. The memory device 300 can include a memory array 301 and peripheral circuits 302 coupled to the memory array 301. The memory array 301 can be a NAND flash memory array that includes NAND memory cells 306 arranged in rows and columns. In some implementations, memory cells 306 in a column (e.g., along z direction) of the memory array 301 are coupled in series and stacked vertically. Memory cells 306 in a row (e.g., along x direction) of the memory array 301 are coupled to and controlled by a word line 318. Each memory cell 306 can hold a continuous, analog value, such as an electrical voltage or charge that depends on the number of electrons trapped within a storage layer of the memory cell 306. The logic state (i.e., data) of each memory cell 306 can be determined based on the threshold voltage Vth of the memory cell 306. Each memory cell 306 can be a floating gate type memory cell including a floating-gate transistor, or a charge trap type memory cell including a charge-trap transistor.

In some implementations, the memory device 300 can be configured to operate in a single-level cell (SLC) mode. To increase storage density, the memory device 300 can also be configured to operate in a multi-level cell (MLC) mode that can store more than 1 bit per memory cell. The MLC mode can include a triple-level cell (TLC) mode, a quad-level cell (QLC) mode, a penta-level cell (PLC) mode, or a combination of any of these modes. In the SLC mode, a memory cell 306 stores 1 bit and has two logic states, logic {1 and 0}, i.e., states ER and S1. In a MLC mode, a memory cell 306 stores 2 bits, and has four logic states, logic {11, 10, 01, and 00}, i.e., states ER, M1, M2, and M3. In the TLC mode, a memory cell 306 stores 3 bits, and has eight logic states, logic {111, 110, 101, 100, 011, 010, 001, 000}, i.e., states ER, and states T1-T7. In the QLC mode, a memory cell 306 stores 4 bits and has 16 logic states, logic {1111, 1110, 1101, 1100, 1011, 1010, 1001, 1000, 0111, 0110, 0101, 0100, 0011, 0010, 0001, 0000}, i.e., states ER, and states Q1-Q15. In the PLC mode, a memory cell 306 stores 5 bits and has 32 logic states, i.e., state ER, and states Q1-Q31.

As shown in FIG. 3A, memory cells 306 in a column of the memory array 301 can be coupled to a source select gate (SSG) transistor 310 at its source end, and a drain select gate (DSG) transistor 312 at its drain end. The SSG transistor 310 and the DSG transistor 312 can be configured to activate selected columns of the memory array 301 during read and program operations. In some implementations, sources of the SSG transistors in the same memory block are coupled through a same source line 314 (a.k.a., common source line, CSL). The drain of each DSG transistor is coupled to a respective bit line 316. From the bit line 316, data can be read from, or written to memory cells in the column of memory array 301. In some implementations, each column of the memory array 301 is configured to be selected or deselected by applying a DSG select voltage or a DSG unselect voltage to the gate of the respective DSG transistor 312 through one or more DSG lines 313, and/or by applying a select voltage or a unselect voltage to the gate of the respective SSG transistor 310 through one or more SSG lines 315.

In some implementations, the memory cells 306 in adjacent columns can be coupled through word lines 318. The word line 318 can select which row of memory cells 306 is affected by read and program operations. In the SLC mode, a row of memory cells 306 (e.g., memory cells in a string 334 that is coupled to the same word line 318) can store one logical page of data, and therefore corresponds to one logical page. In the MLC mode, one row of memory cells 306 can store two logical pages of data, and therefore corresponds to two logical pages (e.g., a lower page and an upper page). In the TLC mode, a row of memory cells 306 can store three logical pages of data, and therefore corresponds to three logical pages (e.g., a lower page, a middle page, and an upper page). In the QLC mode, one row of memory cells 306 can store four logical pages of data, and therefore corresponds to four logical pages (e.g., a lower page, a middle page, an upper page, and an extra page). In the PLC mode, one row of memory cells 306 can store five logical pages of data, and therefore corresponds to five logical pages.

In some implementations, the memory array 301 can include a plurality of memory blocks (e.g., a memory block 304 as shown in FIG. 3B), and each memory block can include a plurality of strings 334. As shown in FIG. 3A, each string 334 can include memory cells 306 arranged in rows (e.g., coupled to word lines along the X direction) and in columns (e.g., connected in series along the Z direction). Different strings 334 in the same memory block are coupled together to the same source line 314. DSG lines 313 of different strings 334 are separate from each other, so that each string 334 in the memory block can be selected or deselected by applying a select voltage or an unselect voltage to the respective DSG lines 313.

Peripheral circuits 302 can be coupled to memory array 301 through bit lines 316, word lines 318, source lines 314, SSG lines 315, and DSG lines 313. Peripheral circuits 302 can include any suitable analog, digital, and mixed-signal circuits for facilitating the operations of memory array 301.

FIG. 3B illustrates an example of a schematic diagram of a memory block 304 including strings 334, according to some aspects of the present disclosure. In some implementations, each memory block 304 can serve as a basic data unit for erase operations, such that memory cells 306 in the same memory block 304 are erased at the same time. To erase memory cells 306 in a selected memory block 304, the source line 314 coupled to the selected memory block 304 can be biased with an erase voltage. For example, the erase voltage can be a high positive voltage (e.g., 20 V or more). In some implementations, an erase operation can be performed at a half-memory block level, a quarter-memory block level, or a level having any suitable number of memory blocks or fractions of a memory block.

In some implementations, memory blocks 304 in the memory device 300 can be configured to operate in different storage modes. For example, in a memory device, one or more memory blocks are configured to operate in the SLC mode, and one or more memory blocks are configured to operate in a MLC mode (e.g., a QLC mode or a PLC mode). When writing data to the memory device, the memory device can first write the data to memory blocks in the SLC mode (e.g., cache writing), which can reduce the program time and save buffer space. The memory device can then read data from the memory blocks in the SLC mode, and then write the data to memory blocks in the MLC mode, so that the data can be stored in the memory blocks in the MLC mode.

The memory block 304 can include a plurality of strings 334. In some implementations, the memory block 304 can be divided into fingers 344. Each finger 344 can include one or more strings 334. SSG transistors 310 of strings 334 in the same finger 344 are coupled to the same SSG line 315. For example, SSG transistors 310 of strings 334 of the first finger 344a are coupled to a first SSG line represented by SSG0; SSG transistors 310 of strings 334 of the second finger 344b are coupled to a second SSG line represented by SSG1.

In some implementations, DSG transistors 312 of different strings 334 are coupled to different DSG lines 313. For example, DSG transistors 312 of a first string in the memory block 304 are coupled to a first DSG line represented by DSG0; DSG transistors 312 of a second string in the memory block 304 are coupled to a second DSG line represented by DSG1; DSG transistors 312 of a third string in the memory block 304 are coupled to a third DSG line represented by DSG2; and DSG transistors 312 of a fourth string in the memory block 304 are coupled to a fourth DSG line represented by DSG3.

In some implementations, memory cells of the same vertical position (e.g., along z direction) in all strings 334 of the memory block 304 are coupled to the same word line. That is, a word line can be coupled to one row of memory cells of each string 334 of the memory block 304.

In some implementations, the memory block 304 can include a different number of fingers 344, and each finger 344 can include a different number of strings 334. In some implementations, the strings 334 are not arranged in to fingers 344, such that SSG transistors of all strings 334 of the memory block 304 are coupled to the same SSG line.

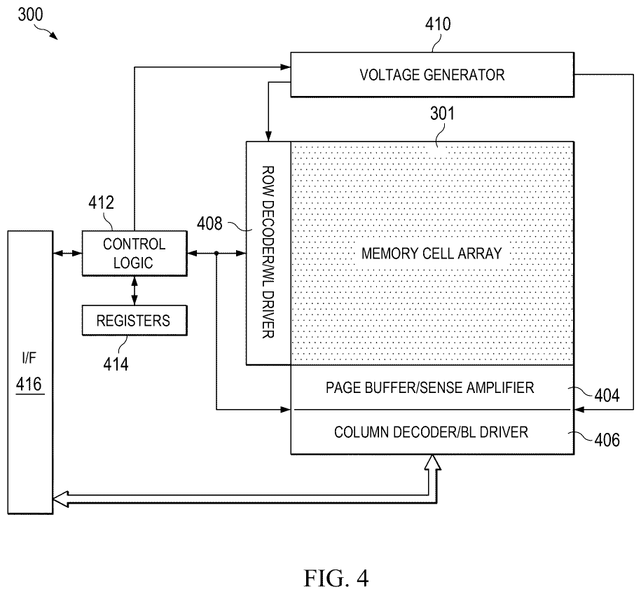

FIG. 4 illustrates some example peripheral circuits 302, according to some aspects of the present disclosure. The peripheral circuits 302 can be coupled to the memory array 301 through bit lines 316, word lines 318, source lines 314, SSG lines 315, and DSG lines 313. The peripheral circuits 302 can include any suitable analog, digital, and mixed-signal circuits for facilitating the operations of the memory array 301 by applying and sensing voltage signals and/or current signals to and from each target memory cell 306 through bit lines 316, word lines 318, source lines 314, SSG lines 315, and DSG lines 313. The peripheral circuits 302 can include various types of peripheral circuits formed using metal-oxide-semiconductor (MOS) technologies. The example peripheral circuits 302 include a page buffer/sense amplifier 404, a column decoder/bit line driver 406, a row decoder/word line driver 408, a voltage generator 410, control logic 412, registers 414, an interface 416, and a data bus. In some examples, additional peripheral circuits not shown in FIG. 4 may be included as well.

The page buffer/sense amplifier 404 can be configured to read and program (write) data from and to memory array 301 according to the control signals from control logic 412. In an example, the page buffer/sense amplifier 404 may store one page of program data (write data) in the memory array 301. In another example, the page buffer/sense amplifier 404 may perform program verify operations to ensure that the data have been properly programmed into memory cells 306 coupled to selected word lines 418. In still another example, the page buffer/sense amplifier 404 may also sense the low power signals from the bit line 316 that represents a data bit stored in memory cell 306, and amplify the small voltage swing to recognizable logic levels in a read operation. The column decoder/bit line driver 406 can be configured to be controlled by the control logic 412 and select one or more columns of memory cells by applying bit line voltages generated from the voltage generator 410.

The row decoder/word line driver 408 can be configured to be controlled by the control logic 412 and select/deselect memory blocks of the memory array 301 and select/deselect word lines 418 of the memory block. The row decoder/word line driver 408 can be further configured to drive word lines 418 using word line voltages generated from the voltage generator 410. In some implementations, the row decoder/word line driver 408 can also select/deselect and drive SSG lines 315 and DSG lines 313. As described below in detail, the row decoder/word line driver 408 is configured to apply a program voltage to selected word line 418 in a program operation on memory cell 306 coupled to selected word line 418.

The voltage generator 410 can be configured to be controlled by the control logic 412 and generate the word line voltages (e.g., read voltage, program voltage, pass voltage, local voltage, verify voltage, etc.), bit line voltages, and source line voltages to be supplied to the memory array 301.

The control logic 412 can be coupled to each peripheral circuit described above and configured to control the operations of each peripheral circuit. The registers 414 can be coupled to the control logic 412 and include status registers, command registers, and address registers for storing status information, command operation codes (OP codes), and command addresses for controlling the operations of each peripheral circuit.

The interface 416 can be coupled to the control logic 412 and act as a control buffer to buffer and relay control commands received from a host (not shown) to the control logic 412 and status information received from the control logic 412 to the host. The interface 416 can also be coupled to the column decoder/bit line driver 406 via a data bus, and act as a data input/output (I/O) interface and a data buffer to buffer and relay data to and from the memory array 301.

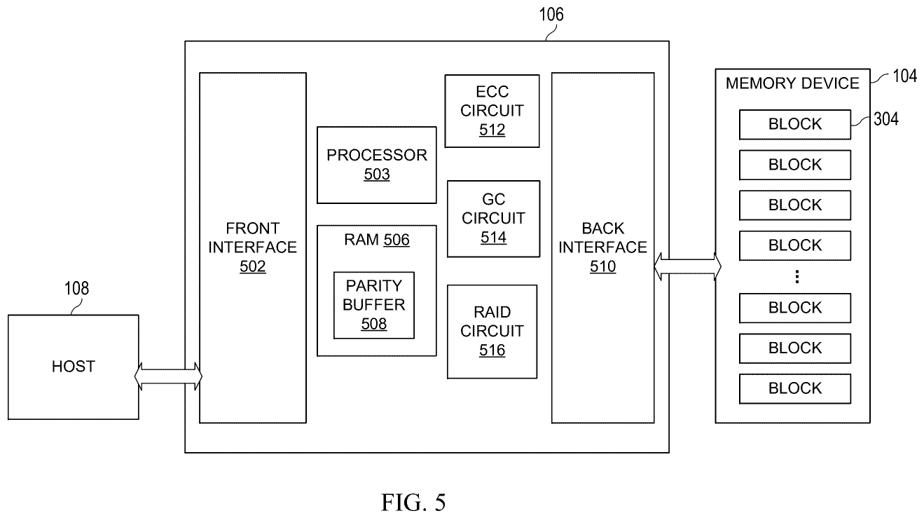

FIG. 5 illustrates an example of a block diagram of a memory controller 106 interacting with a host 108 and a memory device 104, according to some aspects of the present disclosure.

The memory controller 106 can include a front interface 502, one or more processors 503, a Random-Access Memory (RAM) 506, and a back interface 510. The RAM 506 can include one or more parity buffers 508. The memory controller 106 can include an error-correction code (ECC) circuit 512, a garbage collection (GC) circuit 514, and a redundant array of independent disks (RAID) circuit 516. In some examples, additional components not shown in FIG. 5 may be included in the memory controller 106 as well.

The front interface 502 can be configured to handle communications between the host 108 and the memory controller 106. In some implementations, the front interface 502 can communicate with the host 108 according to a particular communication protocol. For example, the front interface 502 can communicate with the host 108 through at least one of various interface protocols, such as a USB protocol, an MMC protocol, a PCI protocol, a PCI-E protocol, an ATA protocol, a serial-ATA protocol, a parallel-ATA protocol, a SCSI protocol, an ESDI protocol, an IDE protocol, a Firewire protocol, etc. In some implementations, the front interface 502 can receive a request from the host 108 and forward the request to the back interface 510, so that the back interface 510 can fulfill the request. Examples of a request can include, but are not limited to, a read request to read data stored in a memory block of memory device 104, an erase request to erase the data in the memory block, a write request to write new data into the memory block, a reformatting request to reformat the memory device 104, or any other suitable request. In some implementations, the front interface 502 can receive data from the back interface 510, and send the data to the host 108.

The back interface 510 can be configured to fulfill requests from host 108. In some implementations, the back interface 510 can receive a request from the host 108 via the front interface 502, and perform one or more operations to fulfill the request. For example, the back interface 510 can be configured to control operations of memory device 104 (e.g., read, erase, or program operations) in response to receiving a request from host 108 (e.g., a read request, an erasing request, or a programming request). The back interface 510 can also be configured to manage various functions with respect to the data stored or to be stored in the memory device 104 including, but not limited to, bad-block management, error correction, wear leveling, garbage collection, RAID parity check, etc.

The ECC circuit 512 is configured to process error correction codes with respect to the data read from or written to the memory device 104. Example error correction codes can include, but are not limited to, Hamming codes, Reed-Solomon codes, low-density parity check (LDPC) codes, etc. In some implementations, the ECC circuit 512 includes an LPDC encoder configured to generate parity data based on LDPC codes for user data received from the host 108, so that both the user data and the parity data can be sent to the memory device 104 for storage. The ECC circuit 512 can further include an LDPC decoder configured to decode data comprising the user data and the parity data. The ECC circuit can determine whether data stored in the block is read successfully (e.g., with no errors). If the data stored in the block is read successfully, the back interface 510 can forward the data to the front interface 502, so that the front interface 502 can return the data to the host 108. However, if the data stored in the memory block is not read successfully, the back interface 510 can generate data describing a read error on the memory block.

The GC circuit 514 can be configured to migrate data from a source memory block to a target memory block, so that the source memory block can be erased to be available for writing new data. For example, the GC circuit 514 can be configured to select a source memory block and a target memory block in the memory device 104, read valid data from the source memory block by sending read commands to the memory device 104, write the valid data to the target memory block by sending write commands to the memory device 104, and then erase the source memory block. In some implementations, the GC circuit 514 can be configured to perform foreground garbage collection on the memory device 104, where the garbage collection is performed when there are not enough memory blocks available for writing new data. In some implementations, the GC circuit 514 can be configured to perform background garbage collection on the memory device 104, where the garbage collection is performed while the memory device is idle (e.g., when there is no pending command to be executed by the memory device).

The RAID circuit 516 can be configured as a RAID encoder and/or a RAID decoder. The RAID circuit 516 (e.g., the RAID encoder) can be configured to generate RAID parity data by performing encoding operations on data to be written to the memory device 104, so that the data and the corresponding RAID parity data can be written to the memory device for storage. In case of data failure, the RAID circuit 516 (e.g., the RAID decoder) can be configured to recover a compromised data portion by performing decoding operations on uncompromised data portions and corresponding RAID parity data. The memory device 104 can be managed under a RAID scheme, which employs techniques of striping, mirroring, and/or parity to create large reliable data storage across multiple storage units. In some implementations, the memory device 104 can include one or more dies, where each die includes multiple planes. Each plane includes multiple memory blocks. Each memory block can store data in multiple pages (e.g., logical pages). Pages located at the same position (e.g., associated with word lines of identical numbers and included in strings of identical numbers) across different planes in at least one die can form a page line 602. The RAID circuit 516 can perform exclusive OR (XOR) operations among data in one or more page lines to generate respective RAID parity data.

In some implementations, page lines 602 can be grouped into a plurality of rounds. The RAID circuit 516 can perform separate encoding operations on each page line in the same round, such that any two page lines in the same round do not share the same RAID parity data. Further, one or more rounds can form a fund. After performing encoding operations on page lines included in a fund to generate corresponding RAID parity data, the corresponding RAID parity data can be written to the last round of the fund, for example, to the last page of each page line included in the last round of the fund. In some implementations, the number of page lines 602 included in a round can be set according to the RAID scheme implemented by the memory controller. For example, under a 1 WL RAID scheme, the number of page lines included in one round can be identical to the number of page lines associated with one word line; under a 2 WL RAID scheme, the number of page lines included in one round can be identical to the number of page lines associated with two word lines. Further, the number of rounds included in a fund can be set according to a volume ratio of RAID parity to user data in the memory device. For example, under the same RAID scheme, if more rounds are included in a fund, the volume ratio of RAID parity to user data is greater.

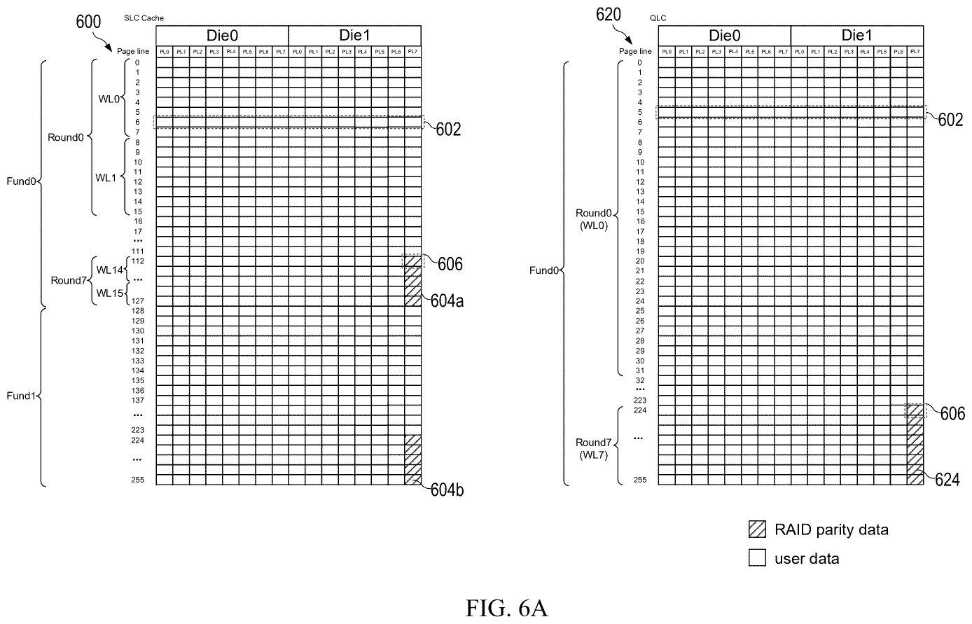

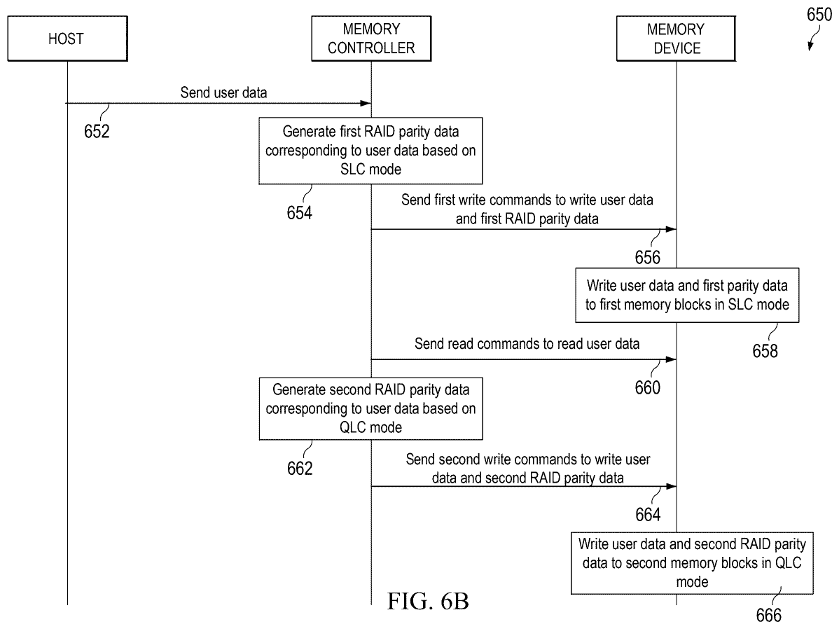

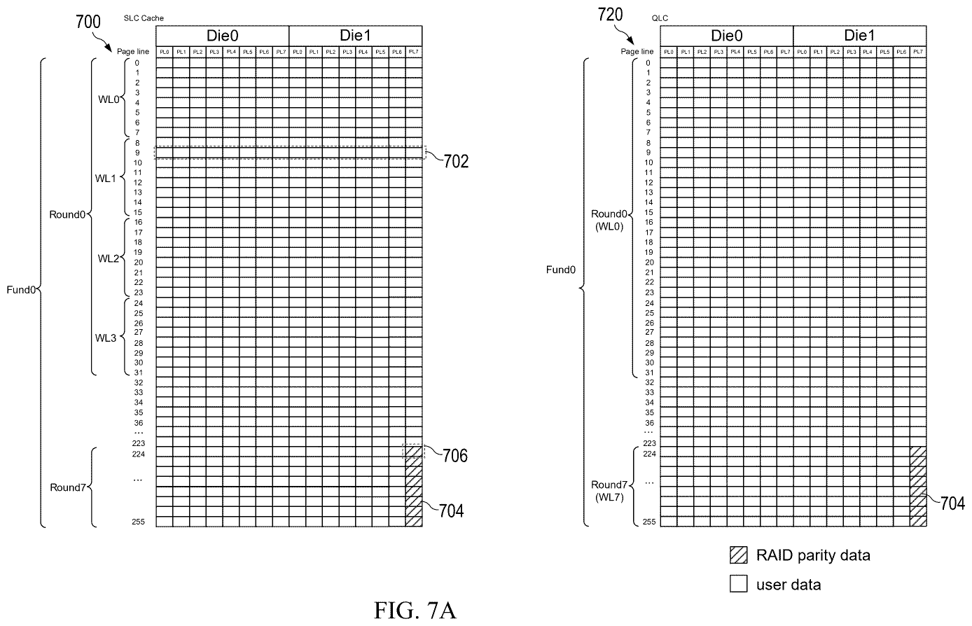

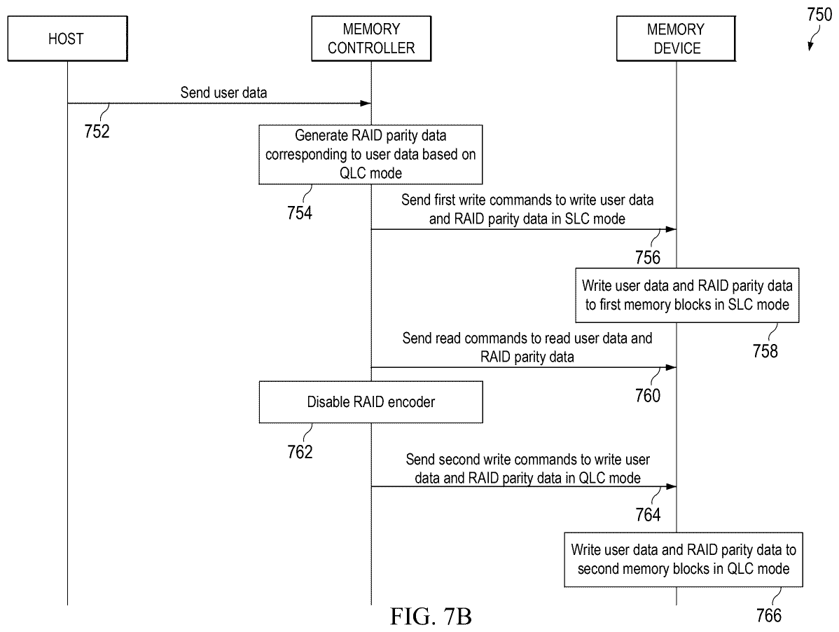

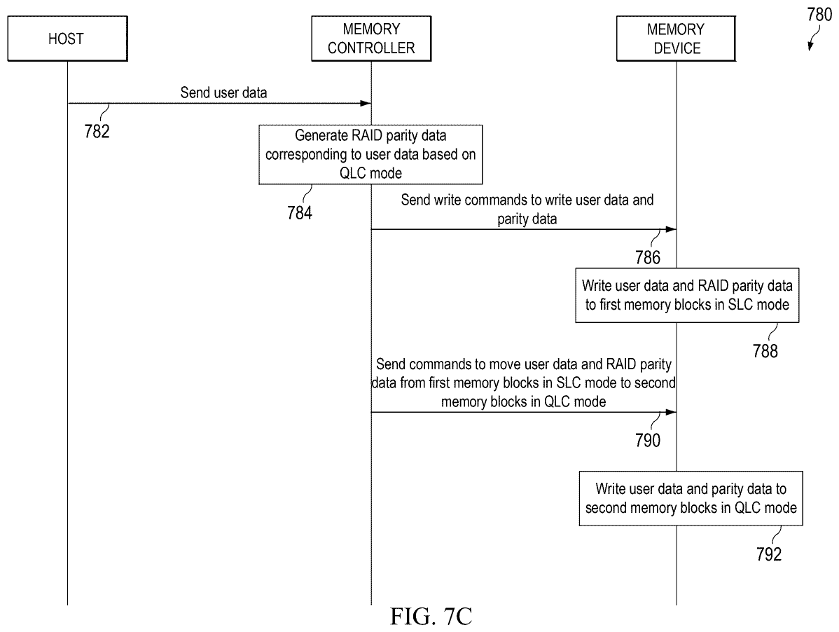

As an example shown in FIGS. 6A and 7A, the memory device includes 2 dies, DIE0 and DIE1. Each die includes 8 planes, PL0-PL7. Each plane includes a plurality of memory blocks. As such, each page line 602, 702 includes 16 pages, which are located at the same position across the 16 planes. Each memory block include pages that are associated with a plurality of word lines (e.g., WL0-WLn). The number of pages associated with one word line depends on the storage mode of the memory block and the number of strings (e.g., string 334 of FIG. 3B) included in the memory block. For example, memory blocks 600, 700 are configured to operate in the SLC mode and each memory block 600, 700 includes 8 strings, such that each word line is associated with 8 page lines 602, 702 (one page line from each string). For instance, WL0 is associated with page lines 0-7, WL1 is associated with page lines 8-15, and so on. For another example, memory blocks 620, 720 are configured to operate in the QLC mode and each memory block 620, 720 includes 8 strings, such that each word line is associated with 32 page lines 602, 702 (four page lines from each string, i.e., lower page line, middle page line, upper page line, and extra page line). For instance, WL0 is associated with page lines 0-31, WL1 is associated with page lines 32-63, and so on.

It should be noted that the memory device can include any other suitable number of dies and other suitable number of planes, and that each page line can include any other suitable number of pages.

Referring back to FIG. 5, the one or more processors 503 are configured to control operations of the memory controller 106. The one or more processors 503 are configured to control a read operation, a program operation, an erase operation, or other operations of the memory device 104.

The RAM 506 is configured to be used as an operation memory of the one or more processors 503, a cache memory between the memory device 104 and the host 108, and/or a buffer memory between the memory device 104 and the host 108. In some implementations, the RAM 506 can be a Static Random-Access Memory (SRAM). The RAM 506 can include one or more parity buffers 508 configured to store RAID parity data and/or the intermediate results of XOR operations to generate the RAID parity data. In some implementations, the RAM 506 can further include one or more read buffers configured to temporarily store data that are read from the memory device 104, one or more copy buffers configured to temporarily store data to be written to the memory device 104, or the like.

In some implementations, each parity buffer 508 may have a limited memory space (e.g., 320 KB). In case the RAID parity data and/or the intermediate results exceed the memory space of the parity buffer 508, the memory controller 106 may use other buffers (e.g., the read buffer and the copy buffer) in the RAM 506 to store the RAID parity data and/or the intermediate results. In case the RAID parity data and/or the intermediate results exceed available buffer space in the RAM 506, the memory controller 106 may perform swap operations, e.g., sending the RAID parity data and/or the intermediate results in the parity buffer 508 to the memory device 104 for temporary storage, and retrieving the RAID parity data and/or the intermediate results from the memory device 104 when needed.

FIG. 6A illustrates an example data structure of a memory device (e.g., the memory device 104 of FIGS. 1-2B and 5, the memory device 300 of FIG. 3A), according to some aspects of the present disclosure. FIG. 6B illustrates an example process 650 of writing data to the memory device as shown in FIG. 6A. The memory device can include memory blocks 600 that are programmable in a storage mode having a lower storage density (e.g., SLC mode), and memory blocks 620 that are programmable in a storage mode having a higher storage density (e.g., a MLC mode such as a QLC mode or PLC mode). In the following, memory blocks 600 in the SLC mode and memory blocks 620 in the QLC mode are used as an example for illustration.

At 652, a host (e.g., the host 108 of FIGS. 1 and 5) sends user data to the memory controller. The host can further send one or more write commands to a memory controller (e.g., the memory controller 106 of FIGS. 1-2B and 5) that indicate to write the user data to the memory device. In response to receiving the user data, the memory controller can first perform cache writing by writing the user data to memory blocks 600 in the SLC mode. The memory controller can then write the user data to memory blocks in a storage mode with a higher storage density, for example, memory blocks 620 in the QLC mode.

At 654, the memory controller generates first RAID parity data 604a, 604b (collectively 604) corresponding to the user data based on the SLC mode. In some implementations, the RAID circuit (e.g., the RAID circuit 516 of FIG. 5) can implement a 1 WL protection scheme, such that each round includes page lines 602 associated with one word line. In some implementations, as shown in FIG. 6A, the RAID circuit of the memory controller can implement a 2 WL RAID scheme, such that each round includes page lines 602 associated with two adjacent word lines. The first RAID parity data 604a of a fund (e.g., fund0) include a plurality of parity pages 606. A parity page 606 is generated by performing XOR operating among data pages in a set of page lines 602, where the set of page lines 602 include a page line 602 from each round of the fund. The memory controller can allocate a parity buffer to store each parity page 606 and/or corresponding intermediate results for generating the parity page 606, before writing the parity page 606 to the memory blocks 600. For memory blocks 600 in the SLC mode and under the 2 WL RAID scheme, the number of parity pages included in the RAID parity data 604 of one fund is identical to twice the number of strings included in a memory block 600. As such, the number of parity buffers needed is identical to twice the number of strings included in a memory block 600.

As one example, as shown in the data structure of the memory blocks 600 in the SLC mode, each fund includes 8 rounds (e.g., Round0 to Round 7). Each round includes 16 page lines that are associated with two adjacent word lines. RAID parity data 604 of each fund includes 16 parity pages 606. The memory controller can allocate 16 parity buffers. Each parity buffer stores a parity page and/or the intermediate results for generating one parity page, before the parity page is written to the memory blocks 600.

For instance, the first parity page of RAID parity data 604a of Fund0 is generated based on XOR operations: page line 0 ⊕ page line 16 ⊕ page line 32 ⊕ . . . ⊕ page line 112; the second parity page of RAID parity data 604a of Fund0 is generated based on XOR operations: page line 1 ⊕ page line 17 ⊕ page line 33 ⊕ . . . ⊕ page line 113; . . . ; the last parity page of the RAID parity data 604a of Fund0 is generated based on XOR operations: page line 15 ⊕ page line 31 ⊕ page line 47 ⊕ . . . ⊕ page line 127.

At 656, the memory controller sends one or more first write commands to write the user data and the first RAID parity data 604 to the memory blocks 600 in the SLC mode.

At 658, in response to receiving the one or more first write commands, the memory device writes the user data and the first RAID parity data 604 to the memory blocks 600 in the SLC mode. For example, the RAID parity data 604a of Fund0 is written to the last page of page lines 602 of the last round of Fund0; the RAID parity data 604b of Fund1 is written to the last page of page lines 602 of the last round of Fund1. In some implementations, the memory device writes data to the memory blocks 600 following the sequence of page line number, e.g., from page line 0, to page line 1, . . . , to page line n. In some cases, the memory controller does not generate RAID parity data 604b of Fund1 until the RAID parity data 604a of Fund0 has been written to the memory blocks 600.

At 660, the memory controller sends one or more read commands to read the user data from the memory blocks 600. In some implementations, RAID parity data 604 is not read from the memory blocks 600 during 660.

At 662, the memory controller generates second RAID parity data 624 corresponding to the user data based on the QLC mode. In some implementations, the RAID circuit can implement a 1 WL protection scheme, such that each round includes page lines 602 associated with one word line. The second RAID parity data 624 of a fund (e.g., fund0) includes a plurality of parity pages 606. A parity page 606 of the second RAID parity data 624 is generated by performing XOR operating among data in a set of page lines 602, where the set of page lines 602 include a page line 602 from each round of the fund. For memory blocks 620 in the QLC mode and under the 1 WL RAID scheme, the number of parity pages included in the RAID parity data 624 of one fund is identical to four times the number of strings included in a memory block 620. As such, the number of parity buffers needed is identical to four times the number of strings included in a memory block 620.

As one example, as shown in the data structure of the memory blocks 620 in the QLC mode, each fund includes 8 rounds (e.g., Round0 to Round 7). Each round includes 32 page lines that are associated with one word line. RAID parity data 624 of each fund includes 32 parity pages 606. The memory controller can allocate 32 parity buffers. Each parity buffer stores a parity page 606 and/or the intermediate results for generating one parity page 606, before the parity page 606 is written to the memory blocks 600. A total of 48 parity buffers may be needed during the process 650 (16 parity buffers for generating RAID parity data 604 during cache writing, and 32 parity buffers for generating RAID parity data when moving the data to memory blocks in the QLC mode), which may exceed the buffer space of the RAM of the memory controller. In such case, the memory controller may need to perform swap operations by writing the parity buffer and/or intermediate results to the memory device and retrieving them from the memory device when needed, which can affect the efficiency of overall write operations.

For instance, the first parity page of the RAID parity data 624 of Fund0 is generated based on XOR operations: page line 0 ⊕ page line 32 ⊕ page line 64 ⊕ . . . ⊕ page line 224; the second parity page of the RAID parity data 624 of Fund0 is generated based on XOR operations: page line 1 ⊕ page line 33 ⊕ page line 65 ⊕ . . . ⊕ page line 225; . . . ; the last parity page of the RAID parity data 624 of Fund0 is generated based on XOR operations: page line 31 ⊕ page line 63⊕ page line 95 ⊕ . . . ⊕ page line 255.

At 664, the memory controller sends one or more second write commands to write the user data and the second RAID parity data 624 to the memory blocks 620 in the QLC mode.

At 666, in response to receiving the one or more write commands, the memory device writes the user data and the second RAID parity data 624 to the memory blocks 620 in the QLC mode. For example, the RAID parity data 624 of Fund0 is written to the last page of page lines 602 of the last round of Fund0.

In some implementations, the memory device can include memory blocks configured to operate in the PLC mode. After cache writing, data are read from the memory blocks in the SLC mode and written to the memory blocks in the PLC mod. At 662, the memory controller generates the second RAID parity data corresponding to the user data based on the PLC mode. For example, under 1 WL RAID scheme, each fund can include 8 rounds, and each round can include 40 page lines (e.g., five page lines from each of eight strings). At 664, the memory controller can send one or more second write commands to write the user data and the second RAID parity data to the memory blocks in the PLC mode. At 666, in response to receiving the one or more second write commands, the memory device can write the user data and the second RAID parity data to the memory blocks in the PLC mode. For example, the second RAID parity data of a fund can include 40 parity pages 606, where each parity page 606 is the last page of a page line included in the last round of the fund.

By implementing the process 650, while the user data written to the memory blocks 600 in the SLC mode (e.g., during cache writing) and the user data written to the memory blocks 620 in the QLC mode (e.g., when the data are moved to memory blocks in the QLC mode) may be the same, the first RAID parity data 604 and the second RAID parity data 624 may be different. Further, as shown in FIG. 6A, the position of the second RAID parity data 624 relative to the user data in the memory blocks 620 may be different from the position of the first RAID parity data 604 relative to the user data in the memory blocks 600. For example, the first RAID parity data 604 is stored in page lines 112-127, 240-255, and so on, while the second RAID parity data 624 is stored in page lines 224-255, and so on.

FIG. 7A illustrates an example data structure of a memory device (e.g., the memory device 104 of FIGS. 1-2B and 5, the memory device 300 of FIG. 3A), according to some aspects of the present disclosure. FIG. 7B illustrates an example process 750 of writing data to the memory device as shown in FIG. 7A. The memory device can include memory blocks 700 that are programmable in a storage mode having a lower storage density (e.g., SLC mode), and memory blocks 720 that are programmable in a storage mode having a higher storage density (e.g., a MLC mode such as a QLC mode or a PLC mode). In the following, memory blocks 700 in the SLC mode and memory blocks 720 in the QLC mode are used as an example for illustration.

At 752, a host (e.g., the host 108 of FIGS. 1 and 5) sends user data to the memory controller. The host can further send one or more write commands to a memory controller (e.g., the memory controller 106 of FIGS. 1-2B and 5). The one or more write commands indicate to write the user data to the memory device. In response to receiving the user data, the memory controller can first perform cache writing by writing the user data to memory blocks 700 in the SLC mode (e.g., memory blocks 700). The memory controller can then write the user data to memory blocks in a storage mode with a higher storage density, for example, memory blocks 720 in the QLC mode.

At 754, the memory controller generates RAID parity data 704 corresponding to the user data based on the storage mode with higher storage density (e.g., QLC mode), which the memory blocks 720 are configured to operate in. For example, the RAID circuit (e.g., the RAID circuit 516 of FIG. 5) can implement a 4 WL RAID scheme during cache writing, where each round includes page lines 702 associated with four word lines. A parity page 706 of the RAID parity data 704 of a fund is generated by performing XOR operations among data in a set of page lines 702. The set of page lines 702 include a page line 702 from each round of the fund, that is, the set of page lines 702 are each associated with one of a set of word lines that are separated from each other by three word lines. For memory blocks 700 in the SLC mode and under the 4 WL RAID scheme, the number of parity pages included in the RAID parity data 704 of one fund is identical to four times the number of strings included in a memory block 700. As such, the number of parity buffers needed is identical to four times the number of strings included in a memory block 700.

As one example, as shown in the data structure of the memory blocks 700 in the SLC mode, each fund includes 8 rounds (e.g., Round0 to Round 7). Each round includes 32 page lines that are associated with four word lines (e.g., 8 page lines associated with each of the 4 word lines). RAID parity data 704 of each fund includes 32 parity pages 706. The memory controller can allocate 32 parity buffers. Each parity buffer stores a parity page and/or the intermediate results for generating one parity page, before the parity page is written to the memory blocks 700.

For instance, the first parity page of RAID parity data 704 of Fund0 is generated based on XOR operations: page line 0 ⊕ page line 32 ⊕ page line 64 ⊕ . . . ⊕ page line 224; the second parity page of RAID parity data 704 of Fund0 is generated based on XOR operations: page line 1 ⊕ page line 33 ⊕ page line 65 ⊕ . . . ⊕ page line 225; . . . ; the last parity page of the RAID parity data 704 of Fund0 is generated based on XOR operations: page line 31 ⊕page line 63 ⊕page line 95 ⊕ . . . ⊕ page line 255.

At 756, the memory controller sends one or more first write commands to write the user data and the RAID parity data 704 to the memory blocks 700 in the SLC mode.

At 758, in response to receiving the one or more first write commands, the memory device writes the user data and the RAID parity data 704 to the memory blocks 700 in the SLC mode. For example, the RAID parity data 704 of Fund0 is written to the last page of page lines 702 of the last round of Fund0. In some implementations, the memory device writes data to the memory blocks 700 following the sequence of page line number, e.g., from page line 0, to page line 1, . . . , to page line n.

At 760, the memory controller sends one or more read commands to read the user data and the RAID parity data 704 from the memory blocks 700. In response to receiving the one or more read commands, the memory device sends the user data and the RAID parity data 704 to the memory controller. In some implementations, the memory device sends data following the sequence of page line number, e.g., from page line 0, to page line 1, . . . , to page line n.

At 762, the memory controller disables the RAID encoder of the RAID circuit, so that the memory controller will not generate RAID parity data when writing data during 764-766.

At 764, the memory controller sends one or more second write commands to write the user data and the RAID parity data 704 to the memory blocks 720 in the QLC mode.

At 766, in response to receiving the one or more second write commands, the memory device writes the user data and the RAID parity data 704 to the memory blocks 720 in the QLC mode. Since the RAID parity data 704 is generated based on the QLC mode, the memory device can write the user data and the RAID parity data 704 to positions in memory blocks 720 that are identical to positions in memory blocks 700 where the user data and the RAID parity data 704 are read from. For example, data that are read from page line X (X=0, 1, 2, 3, . . . ) of memory blocks 700 can be written to page line X of memory blocks 720. As a result, a position of the RAID parity data 704 relative to the user data in the memory blocks 700 is identical to a position of the RAID parity data 704 relative to the user data in the memory blocks 720. For example, as shown in FIG. 7A, in memory blocks 700, the RAID parity data 704 of Fund 0 is stored in last pages of page lines 224-255; in memory blocks 720, the RAID parity data 704 of Fund 0 is also stored in last pages of page lines 224-255.

In some implementations, the memory blocks 720 can be configured to operate in another suitable storage mode, and the RAID scheme for generating RAID parity data 704 at 754 can be adjusted according to the storage mode of memory blocks 720. For example, the memory blocks 720 can be configured to operate in the PLC mode. In such case, at 754, when generating the RAID parity data 704, the RAID circuit can implement a 5 WL RAID scheme, where each round includes page lines 702 associated with five word lines. A parity page 706 of the RAID parity data 704 of a fund can be generated by performing XOR operations among data in a set of page lines 702. The set of page lines 702 can include a page line 702 from each round of the fund, that is, the set of page lines 702 are each associated with one of a set of word lines that are separated from each other by four word lines.

By implementing the process 750, the RAID circuit does not need to generate RAID parity data when writing data read from the memory blocks 700 to the memory blocks 720. Further, compared to the process 650, the process 750 requires fewer parity buffers, which can save buffer space and reduce the need for swap operations.

FIG. 7C illustrates another example process 780 of writing data to the memory device as shown in FIG. 7A. 782, 784, 786 and 788 of process 780 can be identical or similar to 752, 754, 756, 758 of process 750, respectively.

At 790, instead of sending one or more read commands so that the memory device can send the user data and the RAID parity data 704 from the memory blocks 700 to the memory controller, the memory controller can send one or more commands to move the user data and the RAID parity data 704 directly from the memory blocks 700 in the SLC mode to the memory blocks 720 in the QLC mode, without sending the data to the memory controller.

At 792, in response to receiving the one or more commands to move the user data and the RAID parity data 704, the memory device can write the user data and the RAID parity data 704 to the memory blocks 720. For example, the memory device can retrieve data from page line X (X=0, 1, 2, 3, . . . ) of the memory blocks 700 and write the data to page line X of the memory blocks 720.

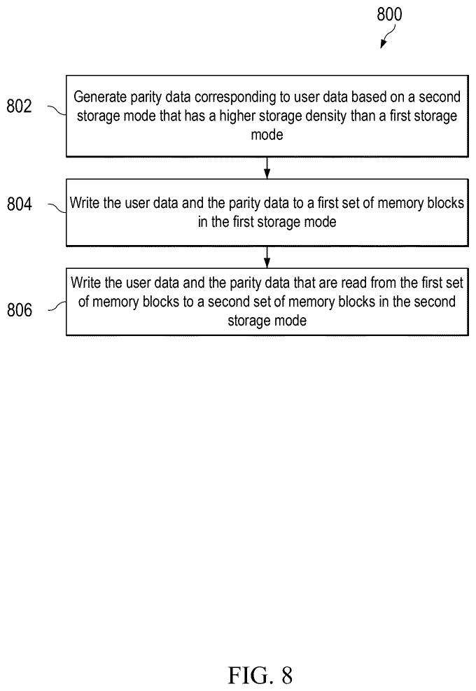

FIG. 8 illustrates a flowchart of an example process 800 of operating a memory system, in accordance with some aspects of the present disclosure. Process 800 can be performed by any suitable device or system as described herein, for example, according to the example techniques described with respect to FIGS. 1-7C. For example, process 800 can be performed by a memory system (e.g., the memory system 102 of FIG. 1) that includes a memory device (e.g., the memory device 104 of FIGS. 1-2B and 5, the memory device 300 of FIG. 3A) and a memory controller (e.g., the memory controller 106 of FIGS. 1-2B and 5). The memory device can include memory blocks programmable in a first storage mode (e.g., SLC mode), or a second storage mode (e.g., an MLC mode such as a QLC mode or a PLC mode) having a higher storage density than the first storage mode.

The operations shown in process 800 may not be exhaustive and other operations can be performed as well before, after, or in between any of the illustrated operations. Further, some of the operations may be performed simultaneously, or in a different order than shown in FIG. 8. In some implementations, some of the operations may be performed by one or more components of a device or a system, such as, a memory controller of a memory system.

At 802, the memory controller generates parity data (e.g., RAID parity data 704 of FIG. 7A) corresponding to user data based on the second storage mode.

In some implementations, the second storage mode is QLC mode. Accordingly, the memory controller generated the parity data by implementing a 4 WL RAID scheme. For example, the parity data includes N parity data portions (e.g., parity pages 706 of FIG. 7A), where each parity data portion is generated by performing XOR operations on M user data portions (e.g., page lines 702 of FIG. 7A). Each of the M user data portions corresponding to one of M word lines (e.g., WL0, WL4, WL8, . . . , WL28) that are separated from each other by three word lines. N and M are positive integers. The number of parity buffers needed is identical to four times the number of strings included in a memory block in the SLC mode.

In some implementations, the second storage mode is PLC mode. Accordingly, the memory controller generated the parity data by implementing a 5 WL RAID scheme. For example, the parity data includes N parity data portions (e.g., parity pages 706 of FIG. 7A), where each parity data portion is generated by performing XOR operations on M user data portions (e.g., page lines 702 of FIG. 7A). Each of the M user data portions corresponding to one of M word lines (e.g., WL0, WL5, WL10, . . . , WL35) that are separated from each other by four word lines. N and M are positive integers. The number of parity buffers needed is identical to five times the number of strings included in a memory block in the SLC mode.

In some implementations, the first storage mode is a XLC mode, where memory blocks configured in the first storage mode can store X bits of data per memory cell (X is a positive integer). The second storage mode is a YLC mode, where memory blocks configured in the YLC mode can store Y bits of data per memory cell (Y is an integer greater than X). Accordingly, the memory controller generates the parity data by implementing a (K/X) WL RAID scheme, where K is the least common multiple of X and Y. For example, the parity data includes N parity data portions (e.g., parity pages 706 of FIG. 7A), where each parity data portion is generated by performing XOR operations on M user data portions (e.g., page lines 702 of FIG. 7A). Each of the M user data portions corresponding to one of M word lines that are separated from each other by K/X word lines. The number of parity buffers needed is identical to K times the number of strings included in a memory block in the first storage mode.

As an example, if the first storage mode is an MLC mode that stores 2 bits per cell and the second storage mode is a QLC mode, the parity data can be generated by implementing a 2 WL RAID scheme. As another example, if the first storage mode is an MLC mode that stores two bits per cell and the second storage mode is a PLC mode, the parity data can be generated by implementing a 5 WL RAID scheme.

At 802, the memory device writes the user data and the parity data to a first set of memory blocks in the first storage mode (e.g., memory blocks 700 in the SLC mode of FIG. 7A).

At 804, the memory device writes the user data and the parity data that are read from the first set of memory blocks to a second set of memory blocks in the second storage mode (e.g., memory blocks 720 in the QLC mode of FIG. 7A). In some implementations, a first position of the parity data relative to the user data in the first set of memory blocks is identical to a second position of the parity data relative to the user data in the second set of memory blocks.

In some implementations, in case of a write failure when writing the user data and the parity data to the second set of memory blocks, the memory controller can read the failed data portion from the first set of memory blocks again. In case of a read failure when reading user data from the second set of memory blocks, the memory controller can recover the comprised data portion by reading the parity data corresponding to the comprised data portion from the second set of memory blocks, and performing XOR operations on the parity data and uncompromised user data. For example, as shown in FIG. 7A, if there is a compromised page in page line 0 of memory blocks 720, the memory controller can recover the compromised page by performing XOR operations on the parity page in page line 224 and other data pages in page line 0, page line 32, page line 64, . . . , page line 224.

The present disclosure also provides a non-transitory computer-readable storage medium. The non-transitory computer-readable storage medium stores one or more instructions (e.g., firmware of a memory controller) that are executable by a computer system. When being executed by the computer system, the instructions in the storage medium can implement the method for managing parity data as shown in FIGS. 1-8.

The non-transitory computer-readable storage medium can be an internal storage unit of the device described in any of the foregoing embodiments. For example, the non-transitory computer-readable storage medium can be a hard disk or an internal memory of the device. The non-transitory computer-readable storage medium can also be an external storage device of the device, such as a plug-in hard disk, a smart media card (SMC), a secure digital (SD) card, a flash card, etc. Further, the non-transitory computer-readable storage medium can also include an internal storage unit and an external storage device.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

As used in this disclosure, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

As used in this disclosure, the term “about” or “approximately” can allow for a degree of variability in a value or range, for example, within 10%, within 5%, or within 1% of a stated value or of a stated limit of a range.

As used in this disclosure, the term “substantially” refers to a majority of, or mostly, as in at least about 50%, 60%, 70%, 80%, 90%, 95%, 96%, 97%, 98%, 99%, 99.5%, 99.9%, 99.99%, or at least about 99.999% or more.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “0.1% to about 5%” or “0.1% to 5%” should be interpreted to include about 0.1% to about 5%, as well as the individual values (for example, 1%, 2%, 3%, and 4%) and the sub-ranges (for example, 0.1% to 0.5%, 1.1% to 2.2%, 3.3% to 4.4%) within the indicated range. The statement “X to Y” has the same meaning as “about X to about Y,” unless indicated otherwise. Likewise, the statement “X, Y, or Z” has the same meaning as “about X, about Y, or about Z,” unless indicated otherwise.

Particular implementations of the subject matter have been described. Other implementations, alterations, and permutations of the described implementations are within the scope of the following claims as will be apparent to those skilled in the art. While operations are depicted in the drawings or claims in a particular order, such operations are not required be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations are not required in all implementations, and the described components and systems can generally be integrated together or packaged into multiple products.

Accordingly, the previously described example implementations do not define or constrain the present disclosure. Other changes, substitutions, and alterations are also possible without departing from the spirit and scope of the present disclosure.

The foregoing description of the specific implementations can be readily modified and/or adapted for various applications. Therefore, such adaptations and modifications are intended to be within the meaning and range of equivalents of the disclosed implementations, based on the teaching and guidance presented herein.

The breadth and scope of the present disclosure should not be limited by any of the above-described example implementations, but should be defined only in accordance with the following claims and their equivalents. Accordingly, other implementations also are within the scope of the claims.

What is claimed is:

1. A memory system, comprising:
a memory device comprising memory blocks programmable in a first storage mode or a second storage mode, wherein the first storage mode has a lower storage density than the second storage mode; and
a memory controller coupled to the memory device, wherein the memory controller is configured to perform operations comprising:
generating, based on the second storage mode, parity data corresponding to user data;
writing, in the first storage mode, the user data and the parity data to a first set of memory blocks; and
writing, in the second storage mode, the user data and the parity data that are read from the first set of memory blocks to a second set of memory blocks.

2. The memory system of claim 1, wherein the first storage mode is a single-level cell (SLC) mode, wherein a memory cell in the first set of memory blocks stores one bit of data,
wherein the second storage mode is a multi-level cell (MLC) mode, wherein a memory cell in the second set of memory blocks stores two or more bits of data, and
wherein the parity data comprises redundant array of independent disks (RAID) parity data.

3. The memory system of claim 2, wherein the second storage mode is a QLC mode,
wherein the parity data comprises N parity data portions, wherein each parity data portion is generated by performing exclusive OR (XOR) operations on M user data portions in the first set of memory blocks, wherein each of the M user data portions corresponds to one of M word lines, and N and M are positive integers, and
wherein the M word lines are separated from each other by three word lines.

4. The memory system of claim 2, wherein the second storage mode is a penta-level cell (PLC) mode,
wherein the parity data comprises N parity data portions, wherein each parity data portion is generated by performing XOR operations on M user data portions in the first set of memory blocks, wherein each of the M user data portions corresponds to one of M word lines, and N and M are positive integers, and
wherein the M word lines are separated from each other by four word lines.

5. The memory system of claim 1, wherein a Redundant Array of Independent Disks (RAID) encoder of the memory controller is disabled when writing the user data and the parity data to the second set of memory blocks.

6. The memory system of claim 1, wherein data in the first set of memory blocks is associated with a first set of pages numbered in sequence, and data in the second set of memory blocks is associated with a second set of pages numbered in sequence,
wherein writing the user data and the parity data that are read from the first set of memory blocks to the second set of memory blocks comprises:
reading data associated with one or more first pages of the first set of pages; and
writing the data to one or more second pages of the second set of pages, wherein page numbers of the one or more first pages and page numbers of the one or more second pages are identical.

7. The memory system of claim 1, wherein a first position of the parity data relative to the user data in the first set of memory blocks is identical to a second position of the parity data relative to the user data in the second set of memory blocks.

8. The memory system of claim 1, wherein the memory controller is configured to perform the operations in response to receiving, from a host, a write command to write the user data.

9. The memory system of claim 1, where the operations comprise:
in response to detecting a write failure when writing the user data and the parity data to the second set of memory blocks, reading the user data and the parity data from the first set of memory blocks again.

10. The memory system of claim 1, wherein the operations comprise:
in response to detecting a read failure when reading the user data from the second set of memory blocks, recovering the user data using the parity data from the second set of memory blocks.

11. A memory controller, comprising:
a processor and an interface, wherein the processor is configured to perform operations comprising:
generating parity data corresponding to user data based on a second storage mode that has a higher storage density than a first storage mode;
sending, through the interface, one or more first write commands to write the user data and the parity data to a first set of memory blocks in the first storage mode;
sending, through the interface, one or more read commands to read the user data and the parity data from the first set of memory blocks; and
sending, through the interface, one or more second write commands to write the user data and the parity data to a second set of memory blocks in the second storage mode.

12. The memory controller of claim 11, wherein a Redundant Array of Independent Disks (RAID) encoder of the memory controller is disabled when writing the user data and the parity data to the second set of memory blocks.

13. The memory controller of claim 11, wherein the first storage mode is a single-level cell (SLC) mode, wherein a memory cell in the first set of memory blocks stores one bit of data,
wherein the second storage mode is a multi-level cell (MLC) mode, wherein a memory cell in the second set of memory blocks stores two or more bits of data, and
wherein the parity data comprises redundant array of independent disks (RAID) parity data.

14. The memory controller of claim 13, wherein the second storage mode is a quad-level cell (QLC) mode,
wherein the parity data comprises N parity data portions, wherein each parity data portion is generated by performing exclusive OR (XOR) operations on M user data portions in the first set of memory blocks, wherein each of the M user data portions corresponds to one of M word lines, and N and M are positive integers, and
wherein the M word lines are separated from each other by three word lines.

15. The memory controller of claim 13, wherein the second storage mode is a penta-level cell (PLC) mode, and
wherein the parity data comprises N parity data portions, wherein each parity data portion is generated by performing XOR operations on M user data portions in the first set of memory blocks, wherein each of the M user data portions corresponds to one of M word lines, and N and M are positive integers, and
wherein the M word lines are separated from each other by four word lines.

16. The memory controller of claim 11, where the operations comprise:
in response to detecting a write failure when writing the user data and the parity data to the second set of memory blocks, reading the user data and the parity data from the first set of memory blocks again.

17. The memory controller of claim 11, wherein the operations comprise:
in response to detecting a read failure when reading the user data from the second set of memory blocks, recovering the user data using the parity data from the second set of memory blocks.

18. A method of operating a memory system, comprising:
generating parity data corresponding to user data based on a second storage mode that has a higher storage density than a first storage mode;
writing the user data and the parity data to a first set of memory blocks in the first storage mode; and
writing the user data and the parity data that are read from the first set of memory blocks to a second set of memory blocks in the second storage mode.

19. The method of claim 18, comprising:
in response to detecting a write failure when writing the user data and the parity data to the second set of memory blocks, reading the user data and the parity data from the first set of memory blocks again.

20. The method of claim 18, comprising:
in response to detecting a read failure when reading the user data from the second set of memory blocks, recovering the user data using the parity data from the second set of memory blocks.
